(19) United States
(12) Patent Application Publication
(10) Pub. No.: US 2006/0064640 A1
(43) Pub. Date: Mar. 23, 2006

(54) Method for editing graphics objects with multi-level input devices

(76) Inventors: Clifton L. Forlines, Cambridge, MA (US); Chia Shen, Lexington, MA (US)

Correspondence Address: Patent Department;Mitsubishi Electric Research Laboratories, Inc., 201 Broadway, Cambridge, MA, 02139, US

(21) Appl. No.: 10/948,805

(22) Filed: Sep. 23, 2004

(51) Int. Cl. G06F 17/00

(52) U.S. Cl. 715/702; 715/744

(57) ABSTRACT

A method edits an object having a current state. A first level of an input device is activated to indicate an intent to edit the object, and the current state is stored in response to activating the first level. The object is edited to a next state. The next state is rejected by deactivating the first level, and restoring the current state. The next state is accepted by activating the second level of the input device, and replacing the current state with the next state.

### FIELD OF THE INVENTION

The present invention relates generally to graphical user interfaces, and more particularly to editing operations with multi-level input devices.

### BACKGROUND OF THE INVENTION

Conventional computers are often equipped with pointing devices to control a pointer on a display device. Typical pointing devices include a mouse, stylus, or trackball. Touch sensitive surfaces can be used to detect pointing devices such as fingers. The pointer can be used in conjunction with a graphical user interface to perform a number of operations including setting a position, manipulating windows, interacting with toolbars, opening menus and selecting menu items, scrolling, and manipulating text or geometric objects in editable applications, e.g., dragging or changing the shape of an object.

Undo is an important feature of any computer application that allows users to make changes, and then to retract the changes if the result is unsatisfactory.

Problems arise due to frequent use of the undo feature and due to inconsistent implementation of the undo feature by software developers.

The undo feature is often provided through a menu, e.g., the edit menu in a graphical user interface (GUI) application, through an icon, or through a keyboard command. A user who is manipulating an object in an editable application, e.g., a text or drawing document, with a mouse or stylus must either move the cursor away from the text object or drawing object being edited and traverse to the application's menu to issue the command or must let go of the mouse entirely to issue a keyboard command. After issuing the command, the user returns to the previously edited object to first make sure that the undo operation has successfully completed, and second to continue working with the document. A small amount of inconvenience in issuing the undo command is multiplied by high frequency of use. Therefore, even small improvements to the issuing of an undo command are desirable.

An example prior art editing operation 100 is shown in FIG. 1. In this example, the user is using a mouse as an input device. The editing operation 100 enables a user to change a current state 101 of an editable object, e.g., a volume control slider of a GUI or a geometric shape in a drawing application. If a next state 141 of the editing is unsatisfactory to the user, the user can undo 160 the editing.

When using a mouse, an object is usually selected for editing by positioning the pointer on top of the object and depressing 110 a mouse button. The current state 101 of the object is stored 120 as a most recent previous state 121 in a memory 125, e.g., an ‘undo stack,’ including other previous states 126 of the document.

When the current state has been stored 120, the user can move 135 the mouse to edit 130 the current state of the object. For example, while the button is depressed, the user can move the volume slider to different positions to change a volume level, or can change the size or position of a geometric shape. When the user releases 140 the mouse button, the next state 141 including the editing is stored 150 as the current state 101. If the user is unhappy with the editing changes, the user can issue 160 an undo command to retrieve 170 the most recent previous state 121 in the memory 125 as the current state 101. However, the user must move the cursor away from the object or use the keyboard to issue the undo command. That is distracting and a waste of time.

Undo is also inconsistently enabled by software developers. In the example described above with respect to FIG. 1, some developers exclude step 120 for many editing actions. For example, most paint applications will allow a user to undo the result of a brush stroke or the changing of a color of an element in the application, but few will allow users to undo the result of picking a new color to paint with. Similarly, an operating system GUI may allow a user to undo the action of deleting a file, but not the action of moving a window across the screen. Text editing applications allow users to undo the results of editing a portion of text, but do not allow users to undo the results of scrolling to a different part of the document, making it difficult to return to a previous location in the text.

Zeleznik, et al., in “Pop through Mouse Button Interactions,” Proceedings of the 14^{th} annual ACM symposium on User interface software and technology, pp. 195-196, 2001, described a range of mouse-based interactions made possible by a two-state “pop through” mouse button. In such a mouse, the user feels a first click when pressing the button lightly, and then as the user continues to press harder a second click is felt. Although this additional state alone increases the input bandwidth of the mouse, the qualitative impact on the user experience can be more pronounced if the state is used meaningfully because the additional state enables the computer to sense a form of expression that involves inherently physically coupled actions.

Ramos, et al. in “Pressure widgets,” Proceedings of the 2004 conference on Human factors in computing systems, pp. 487-494, 2004, described a continuous pressure-sensing stylus to manipulate multi-state objects. There continuous pressure was mapped to visual properties of the pointer, e.g., moving the cursor down a list of menu selections as pressure increases, or to change the appearance of objects, e.g., making objects larger and smaller based on pressure. Ramos uses prior art methods to return to a previous state of an object during editing, which require users to move the cursor off of the object.

Therefore, there is a need for a method for editing an object that allows users to make, save and undo changes while in continuous control of the object without having relocate the pointer to different locations on the display during an undo operation.

### SUMMARY OF THE INVENTION

The invention provides a method for editing an object having a current state. A first level of an input device is activated to indicate an intent to edit the object, and the current state is stored in response to activating the first level. The object is edited to a next state. The next state is rejected by deactivating the first level, and restoring the current state. The next state is accepted by activating the second level of the input device, and replacing the current state with the next state.

### BRIEF DESCRIPTION OF THE DRAWINGS

FIG. 1 is a block diagram of a prior art editing operation; and

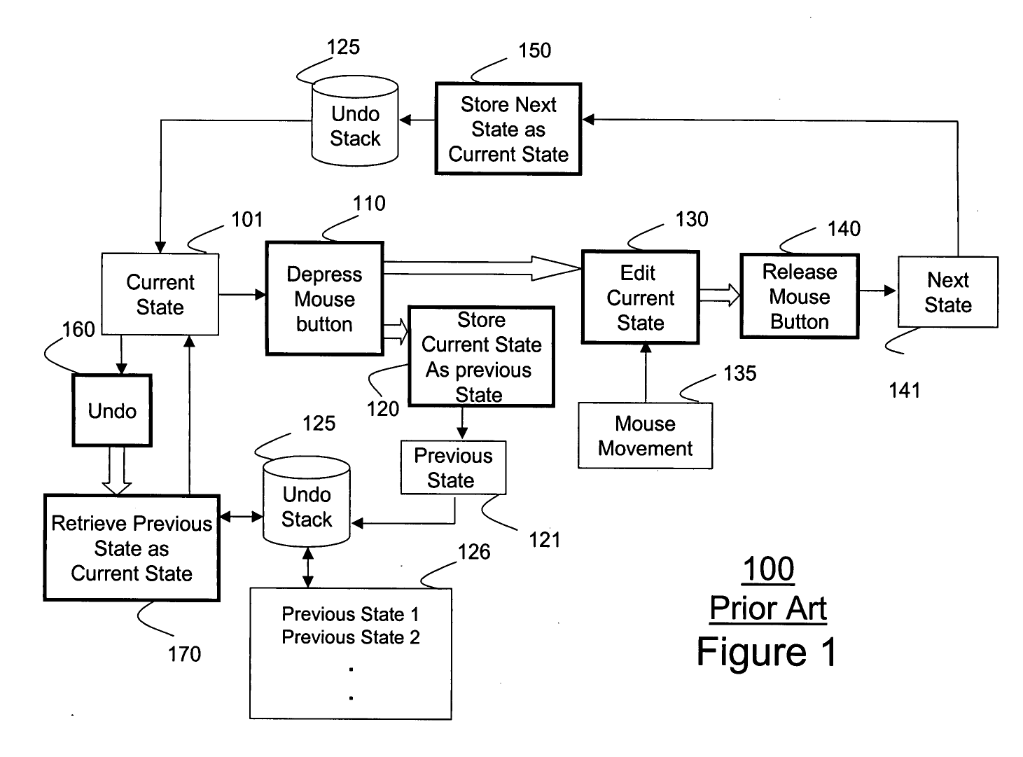

FIG. 2 is a block diagram of editing operations according to the invention.

### DETAILED DESCRIPTION OF THE PREFERRED EMBODIMENT

The invention provides a method for editing objects displayed on a graphical user interface. The method improves the efficiency and quality of user interaction with the graphical user interface during editing operations by enabling users to maintain control of a selected object with a pointer while performing the operations, thus reducing the time required to perform the operations.

The invention uses a multi-level input device. For example, the input device is a touch-senstive surface that can detect distinct first and second levels of pressure. The input device can also be a mouse with two levels of clicking, as desribed above.

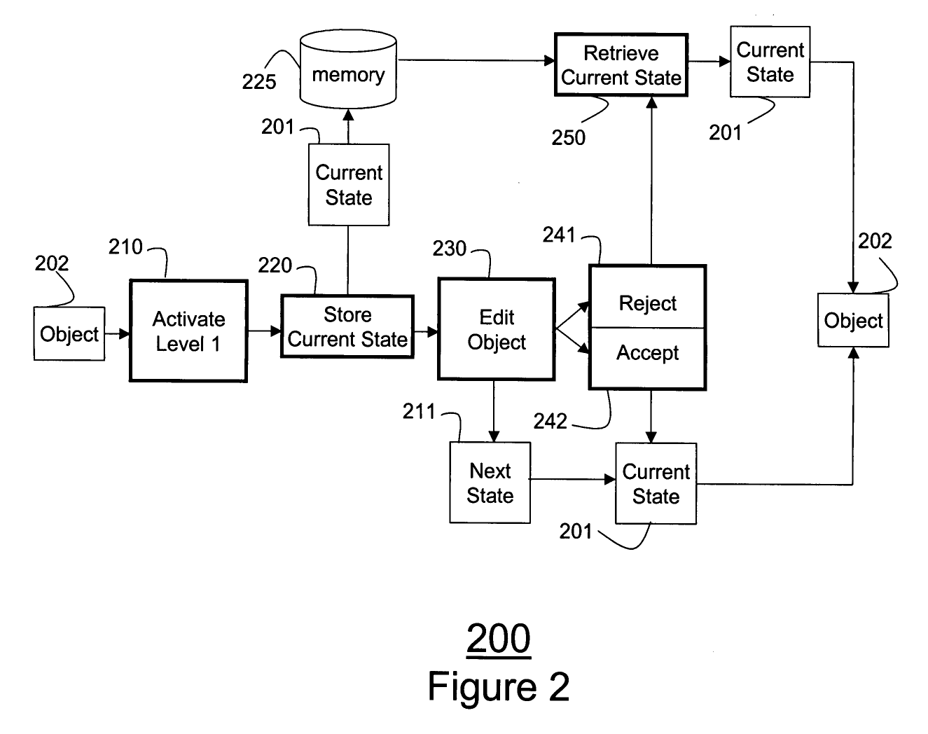

As seen in the editing operation 200 shown in FIG. 2, a selected object 202 displayed on a graphical user interface has a current state 201. In response to activating 210 a first level of the input device, the current state is stored 220 in a memory 225. The first level indicates an intent to edit the object.

At this point, the user can edit 230 the object 202 to a next state 211 by moving the pointer on the display in a conventional manner, while maintaining the input device at the first level. The edit can be a null operation.

When editing is finished, the user can either reject 241 or accept 242 the edit. If the user deactivates the first level of the input device, by either releasing the button, or removing the finger from the touch surface, the edit is ‘undone’ by retrieving 250 the current state 201 of the object 202.

If the user activates the second level, then the next state 211 becomes the current state 201 of the object 202.

In contrast, the prior art requires the user to save the changes, and place the pointer on a menu command, an “undo” icon, or to let go of the mouse and issue a keyboard command to return to the object to the original state before the changes.

In the preferred embodiment, we use a touch sensitive surface as the multi-state input device, see U.S. Pat. No. 6,498,590, “Multi-user touch surface,” issued to Dietz, et al., on Dec. 24, 2002, incorporated herein by reference in its entirety. Each level of the input device is associated with a range of signal strengths produced by the touch sensitive surface.

The input device can also be a pressure sensitive stylus, where levels of the input device are associated with ranges of signal strength of the pressure sensitive stylus.

### EXAMPLES

The invention can be used to perform well-known editing operations such as changing the position, orientation and scale of a graphical object. Other examples are described below.

Color Selection

When editing the color of a graphical object, the user can use first level input to preview the effects of the color change while retaining the ability to return the tool to a previous color. Second level input would confirm the change in color for the object and tool.

Volume Control

The invention enables users to preview new volume levels using the GUI volume control and to quickly return to an accurately set value.

Magnification Tool

The invention enables users to preview different magnification levels of an object and then choose to remain at new level or return to a previous level. For example, the object can be a selected region of a map displayed with the display device.

Window Control

Windows can be moved or resized temporarily with first level input. This is useful with overlapping windows in a GUI in cases where the user wants to check under the foreground window without permanently reorganizing the display device.

Scroll Bar

The invention enables a user to quickly look at another portion of a long document, and then either confirm the scrolling with second level input or return to the previous location by releasing the input.

This invention is described using specific terms and examples. It is to be understood that various other adaptations and modifications may be made within the spirit and scope of the invention. Therefore, it is the object of the appended claims to cover all such variations and modifications as come within the true spirit and scope of the invention.

We claim:

1. A method for editing an object having a current state, comprising:
activating a first level of an input device to indicate an intent to edit the object, and storing the current state in response to activating the first level;
editing the object to a next state;
rejecting the next state by deactivating the first level, and restoring the object to the current state; and
accepting the next state by activating the second level of the input device, and replacing the current state of the object with the next state.

2. The method of claim 1, in which the input device is a multi-state mouse.

3. The method of claim 1, in which the input device is a touch sensitive surface.

4. The method of claim 1, in which the input device is a pressure sensitive stylus.

5. The method of claim 3, in which a range of signal strengths is associated with each input level.

6. The method of claim 1, in which the current state of the object includes a color of the object, and the next state includes a different color.

7. The method of claim 1, in which the current state of the object includes a position of the object, and the next state includes a different position.

8. The method of claim 1, in which the current state of the object includes an orientation of the object, and the next state includes a different orientation.

9. The method of claim 1, in which the current state of the object includes a scale of the object, and the next state includes a different scale.

10. The method of claim 1, in which the current state of the selected object includes a magnification-level of the object, and the next state includes a different magnification-level.

11. The method of claim 1, in which the current state of the selected object includes a volume of the object, and the next state includes a different volume.

12. The method of claim 1, in which the current state of the object includes a region of the object, and the next state includes a different region.
